(19) United States
(12) Patent Application Publication
(10) Pub. No.: US 2010/0227191 A1
(43) Pub. Date: Sep. 9, 2010

(54) Score line corrosion protection for container end walls

(76) Inventors: McKay C. Brown, Aurora, IL (US); Ian Musson Campbell, Goettingen (DE); David Andrew Gill, Bentleyville, OH (US); David S. Wright, Rosdorf (DE)

Correspondence Address: Christopher C. Dunham;c/o Cooper & Dunham LLP, 30 Rockefeller Plaza, New York, NY, 10112, US

(21) Appl. No.: 12/657,876

(22) Filed: Jan. 28, 2010

Related U.S. Application Data
(60) Provisional application No. 61/206,440, filed on Jan. 29, 2009.

(51) Int. Cl. B32B 1/08; B32B 15/01; B32B 15/20

(52) U.S. Cl. 428/586; 428/654

(57) ABSTRACT

The invention relates to an end wall of a metal container having a score therein. The end wall is made of a composite metal sheet made of two or more metal layers, one of the layers being made of an aluminum alloy of high strength (e.g. a high magnesium alloy such as AA5182, AA5042 or AA5082, optionally with increased Mg), and another of the layers being made of an aluminum alloy having a good resistance to stress corrosion cracking (e.g. aluminum alloys AA3004, AA3104, AA5006 or AA5005), wherein at least the bottom of the score is formed by a surface of the alloy of good resistance to stress corrosion cracking.

### CROSS-REFERENCE TO RELATED APPLICATION

This application claims the priority right of prior co-pending provisional patent application Ser. No. 61/206,440 filed Jan. 29, 2009 by applicants named herein. The disclosure of application Ser. No. 61/206,440 is specifically incorporated herein in its entirety by this specific reference.

### BACKGROUND OF THE INVENTION

(1) Field of the Invention

This invention relates to end walls made of aluminum alloys intended for the manufacture of containers and to containers including such end walls. More particularly, the invention relates to end walls scored to facilitate container opening and contents removal. Such end walls are generally, but not exclusively, intended for containers holding foodstuffs and beverages (e.g. carbonated drinks).

(2) Description of the Related Art

Beverage cans and some containers intended for holding foodstuffs and other materials are provided with generally flat or slightly arched end walls that are scored around a localized area intended to function as a partially or fully removable tab or flap when acted on by a ring pull device, roll key, or similar opening device. The score is a groove or channel punched into the metal surface that terminates within the metal layer thickness so that it does not fully penetrate the metal, thereby ensuring that the container remains air- and fluid-tight until opened. The score provides a weakened line that is easily fractured or sheared so that opening requires little effort and can be accomplished by hand. Such end walls are normally produced separately from the remainder of the container and are then mated with a corresponding container body and joined around the periphery to form a completed (and filled) container.

Container end walls must generally be quite strong in order to resist bucking under pressure from within (e.g. when the container holds carbonated beverages, especially if they may be exposed to high temperatures) and denting under forces from without (e.g. from blows or stacking weight encountered during transport and storage). In consequence, aluminum alloys having high strength are generally required and those having high contents of magnesium (Mg, a strengthening element) are normally chosen (e.g. aluminum alloy AA5182 which contains 4-5 wt. % Mg). The magnesium imparts high strength, but makes the alloy vulnerable to corrosion in adverse conditions, and particularly to stress corrosion cracking. Furthermore, high Mg alloys do not usually have an attractive bright appearance, which is sometimes a disadvantage for aesthetic reasons.

When container end walls are subjected to conditions that promote corrosion (e.g. atmospheres of high humidity, exposure to liquids used for washing containers, exposure to anions, or contact with products spilled from nearby split containers), corrosion normally commences within the score, particularly at the bottom, and may lead to score line fracture under stress. As the thickness of metal at the bottom of the score is very thin, even small amounts of stress cracking can lead to score line failure. For example, for a conventional end wall sheet having a total thickness of about 0.208 mm (0.0082 inch), the scoring tool typically penetrates to a depth that leaves (beneath the tool) a metal thickness of 0.091 mm (0.0036 inch or less). Although container end walls are normally made from alloy sheet provided with a coating of protective lacquer or polymer, the score line stamping operation usually cuts through or stresses the lacquer beyond its formability limits on a micro scale around the edges or bottom of the score line. The metal in practice is therefore not fully protected in these areas. Under such circumstances, the alloys also tends to suffer from stress corrosion cracking which may lead to catastrophic failure due to end buckling or can bursts. When a container end wall fails, contents are often transferred to the tops of other nearby containers creating additional score line failure risks. Because of common practices employed in the transport and storage of metal containers, such problems can lead to the catastrophic destruction of very large numbers of containers, causing considerable economic losses and diminution of the manufacturer's reputation.

Corrosion may also start on the inside of the container end wall, even when the inside wall of the container is provided with a polymeric coating made, for example, of vinyl plastics or epoxy resins. During scoring, the product side of the container end wall is compressed and the coating may be thinned or damaged, thereby forming a locus for corrosion. The risk of corrosion increases as the depth of the score increases. Internal corrosion may affect the taste or smell of the contained product and may also increase the risk of bursting failure of the container.

US published patent application no. 2007/0215313 to Wagstaff mentions the cladding of high Mg (AA5XXX) alloy (such as AA5182) with a lower Mg alloy containing 2-3 wt. % Mg or less. However, no use for such clad products is suggested.

U.S. Pat. No. 4,035,201 to Anderson et al. discloses (in the abstract) a can end composed of a core with up to 4 wt. % Mg and clad on the contents side with a layer of essentially pure aluminum with optionally less than 1 wt. % Zn. The function of the cladding is to protect the core from the corrosive contents of the container. However, FIGS. 2 and 3 of the patent show that the score line does not contact, and therefore does not directly benefit from, the cladding material.

Japanese patent publication JP-025573 mentions a core made from an aluminum alloy with up to 7.5 wt. % Mg, and clad on one or both sides with an alloy containing less than or equal to 2 wt. % Mg, among other elements. The stated purpose is to provide a clad material with superior strength and excellent high temperature formability. However, the alloy is intended for use in a marine environment and is thus unrelated to the production of containers for transporting foodstuffs and beverages.

There is therefore a need for improved container end wall design or manufacture to overcome some or all of these problems.

### BRIEF SUMMARY OF THE INVENTION

According to one exemplary embodiment of the present invention, there is provided an end wall of a metal container having a score therein, the end wall comprising a composite metal sheet made of two or more metal layers, one of the layers being made of an aluminum alloy of high strength, and preferably having a magnesium content of 3 wt. % or more, and another of the layers being made of a different aluminum alloy having a good resistance to stress corrosion cracking, and preferably having a magnesium content of less than 3 wt. %. At least the bottom of the score is formed by a surface of the alloy of good resistance to stress corrosion cracking.

It is noted that aluminum alloys having an Mg content of less than 3 wt. % substantially eliminate the incidence of stress corrosion cracking (stress cracking brought on or propagated by corrosion). Such low Mg alloys may still be prone to a degree of corrosion (generally less than high Mg alloys) when exposed to oxygen and a corrosive medium (e.g. water), but the likelihood of stress cracking occurring or propagating as a result of such corrosion is not significantly increased. It appears that stress corrosion cracking is an accelerated form of metal cracking where corrosion and stress act together to form, and especially to propagate, cracks in vulnerable regions of a metal product, leading quickly to product failure. Alloys with higher Mg contents are susceptible to such forms of cracking.

The layer made of aluminum alloy of high strength preferably forms more than half the total thickness of the end wall, and more preferably more than 80% of the total thickness of the end wall.

Another exemplary embodiment provides an end wall for a metal container having a score formed therein, the end wall comprising a composite metal sheet of at least two layers, wherein at least one of the layers is made of an alloy selected from alloy AA5182, alloy AA5042 and alloy AA5082, optionally with increased Mg, and wherein at least one other of the layers is made of an aluminum alloy selected from alloy AA3004, alloy AA3104, alloy AA5006, alloy AA5052 and alloy AA5005.

Another exemplary embodiment of the invention provides a metal container comprising a body having an open end and an end wall closing the open end of the body, wherein the end wall end wall is as defined above.

Aluminum alloys of good resistance to stress corrosion cracking are generally those that score well in ASTM standard testing procedures for assessing resistance to corrosion. A person of ordinary skill in the art would have no difficulty in identifying alloys having good scores or properties in resistance to corrosion. Aluminum alloys of high strength, on the other hand, are generally those having a yield stress value of about 50 ksi or more.

The alloy of high strength is preferably alloy AA5182, but alloys AA5042 and AA5082 are examples of other effective alternatives. Other types of high strength alloys may be used provided the alloy is capable of undergoing necessary manufacturing steps, e.g. a shell-forming process and a conversion process. For beverage cans, in particular, the alloy needs to be able to form a rivet (for attachment of a ring pull tab) from the end wall metal without fracturing, and minimum buckle requirements must be met.

The alloy of high resistance to stress corrosion cracking is preferably selected from alloys of the 3000 series (e.g. AA3004, AA3104), AA5006, AA5052 and alloy AA5005. These alloys have Mg contents below 3 wt. % (in fact, except for AA5052, they have Mg contents below 2 wt. %, and even below 1.5 wt. %) and are therefore free of stress corrosion cracking. Advantageously, these alloys are also recyclable with Used Beverage Can scrap and can be cast with a high scrap metal content.

For an understanding of the number designation system most commonly used in naming and identifying aluminum and its alloys see “International Alloy Designations and Chemical Composition Limits for Wrought Aluminum and Wrought Aluminum Alloys”, published by The Aluminum Association, revised January 2001 (the disclosure of which is incorporated herein by reference).

The composition ranges of the alloys mentioned above are shown in Table 1 below (in wt. %, with the balance Al).

TABLE 1

| Alloy | Si | Fe | Cu | Mn | Mg | Cr | Zn | Ti |
|---|---|---|---|---|---|---|---|---|
| AA5182 | 0-0.20 | 0-0.35 | 0-0.15 | 0.2-0.5 | 4.0-5.0 | 0-0.10 | 0-0.25 | 0-0.10 |
| AA5042 | 0-0.20 | 0-0.35 | 0-0.15 | 0.2-0.5 | 3.0-4.0 | 0-0.10 | 0-0.25 | 0-0.10 |
| AA5082 | 0-0.20 | 0-0.35 | 0-0.15 | 0-0.15 | 4.0-5.0 | 0-0.15 | 0-0.25 | 0-0.10 |
| AA3004 | 0-0.30 | 0-0.70 | 0-0.25 | 1.0-1.5 | 0.8-1.3 | — | 0-0.25 | — |
| AA3104 | 0-0.60 | 0-0.80 | 0.05-0.25 | 0.8-1.4 | 0.8-1.3 | — | 0-0.25 | 0-0.10 |
| AA5006 | 0-0.40 | 0-0.80 | 0-0.10 | 0.40-0.8 | 0.8-1.3 | 0-0.10 | 0-0.25 | 0-0.10 |
| AA5052 | 0-0.25 | 0-0.40 | 0-0.10 | 0-0.10 | 2.2-2.8 | 0.15-0.35 | 0-0.10 | — |
| AA5005 | 0-0.30 | 0-0.70 | 0-0.20 | 0-0.20 | 0.5-1.1 | 0-0.10 | 0-0.25 | — |

The layer of metal of high resistance to stress corrosion cracking is preferably positioned such that it is driven into the score line as the score is formed, so as to coat the sides and bottom of the score and thus provide protection from corrosion cracking. Alternatively, the layer of metal of high resistance to stress corrosion cracking may be positioned so that the bottom of the score terminates in the layer. This ensures that the vulnerable bottom part of the score is formed out of metal resistant to stress corrosion cracking.

In the beverage and food industries, there are two main score designs. The first is commonly referred to as a “Stolle dual score design”, and the second is referred to as a “DRT coined score”. In the case of the Stolle design, two score lines are provided, namely a primary score and a secondary (or “anti-fracture” score) which is typically located inside the primary score with a spacing between the two in the region of 0.050 to 0.125 inch (preferably about 0.080 inch). The primary score is deeper than the secondary score and is the score that is fractured or sheared upon opening. The secondary score affects the residual stresses associated with the primary score so as to prevent micro-cracks in, or premature fracture along, the primary score from container handling during manufacture, transport, storage and use. More information about the Stolle design may be obtained from U.S. Pat. No. 3,954,075 issued to Charles Jordan, U.S. Pat. No. 3,406,866 and British patent No. 1,164,179 (the disclosures of which are specifically incorporated herein by reference).

In the DRT coined design, a single score is employed, but the tool that creates the score has raised shoulders that form a shallow depression in the surface of the metal on each side of the score line itself. This design is discussed in U.S. Pat. No. 5,373,721 which issued to Welsh et al. on Dec. 20, 1994 (the disclosure of which is incorporated herein by reference). The intention of this design is to stiffen the score aperture area and to impart a “crisp” opening action or characteristic. However, the coining tends to add metal stresses during the score coining operation and this can lead to metal fractures that may initiate corrosion. Scores of this kind are believed to be more susceptible to corrosion and stress corrosion cracking than to those of the Stolle design. However, exemplary embodiments of the present invention may be used with both (or other) score designs.

### BRIEF DESCRIPTION OF THE SEVERAL VIEWS OF THE DRAWINGS

FIG. 1 is a top plan view of a typical conventional beverage container provided with an end wall having a score for easy opening;

FIG. 2 is a drawing of a photomicrograph showing a section of a container end wall on a magnified scale in the region of the score;

FIG. 3 is a drawing similar to that of FIG. 2, but showing a container end wall having internal corrosion;

FIGS. 4 to 7 are schematic drawings showing cross-sections showing alternative exemplary embodiments of the present invention together with score line tools in some of the drawings;

FIG. 8 is a graph showing how corrosion is linked to compression used during the production of the score;

FIG. 9 is a top plan view similar to FIG. 1 showing the locations (1, 2 and 3) where testing was carried out as explained in the Example;

FIGS. 10a and 10b, 11a and 11b, 12a and 12b, 13a and 13b and 14a are photomicrographs showing results explained in the Example; and

FIGS. 14b and 14c are printouts from scanning electron microscope tests of metal from parts A and B, respectively, of the sample shown in FIG. 14a disclosing Mg contents of the metal parts.

### DETAILED DESCRIPTION OF THE EXEMPLARY EMBODIMENTS

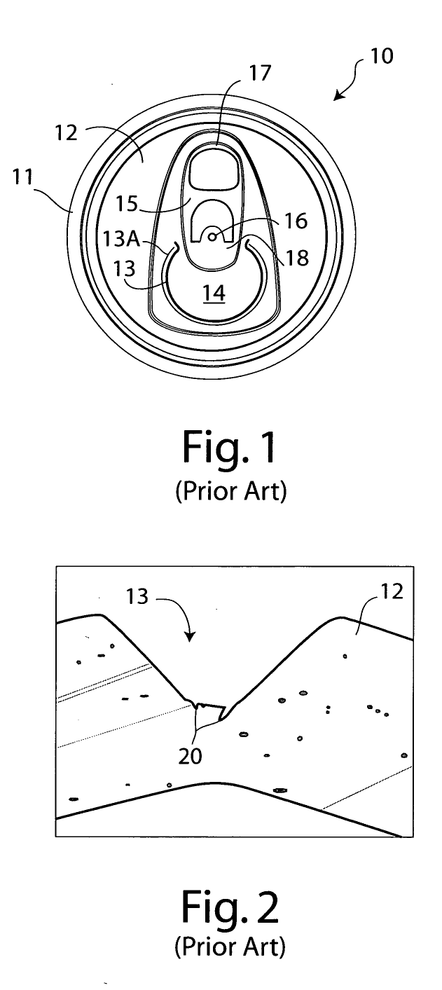

FIG. 1 of the accompanying drawings is top plan view of a modern beverage container 10 showing a container side wall 11 and a container end wall 12. The end wall incorporates a score 13 that partially penetrates the metal of the end wall and surrounds an area of the end wall forming an openable tab 14. A corresponding “anti-fracture” score 13A is also provided closely surrounding the score 13 to impart a Stolle dual score design as mentioned above. Score 13 penetrates more deeply into the metal of the container end wall than score 13A. The end wall is provided with a ring pull 15 secured to the end wall by a rivet 16 created from the metal of the end wall. Raising the free end 17 of the ring pull causes the opposite end 18 to act as a lever pivoted at the rivet 16, and the downward force thereby produced shears the metal at the bottom of the score 13 and forces the tab 14 to pivot downwardly into the container. The contents of the container may then be removed through the resulting opening.

FIG. 2 is a reproduction of a photomicrograph showing a magnified section of a conventional container end wall 12 of the kind shown in FIG. 1 in the region of the score 13. The end wall 12 has become upwardly arched under the internal pressure of carbonated beverages and stress cracks 20 are starting to form at the base of the score 13. It is in and around such stress cracks that corrosion commences and propagates when the container is exposed to a corrosive element or atmosphere. Corrosion does not usually commence on the sides of the score and it seems that stress cracking is a key requirement. The bottom of the score is therefore the vulnerable part.

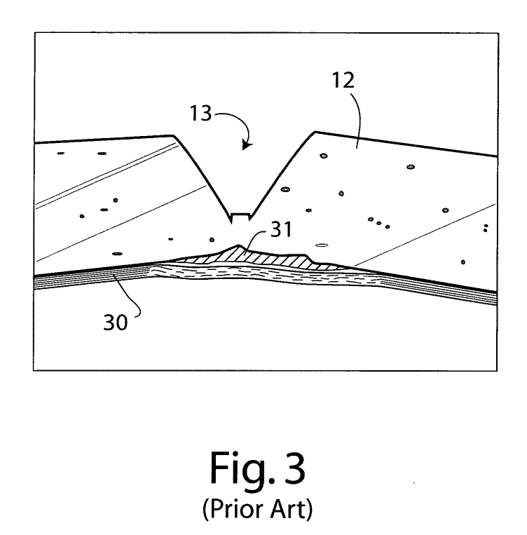

FIG. 3 is a view similar to FIG. 2, showing how corrosion may commence inside the container due to coating flaws and damage produced during scoring. The container end wall 12 is normally provided with an internal coating 30 of lacquer, epoxy or vinyl polymeric material. During the formation of the score 13, the coating 30 may become attenuated, cracked or otherwise damaged so that corrosion 31 may commence and grow, especially when the beverage or foodstuff contains corrosive components. Eventually, the coating is pushed away from the end wall in the region where corrosion forms, thus allowing the corroded region to spread and grow.

According to one preferred exemplary embodiment of the present invention, a container end wall is made from a composite metal sheet in which a high strength aluminum alloy provided for its good buckle resistance is bonded or fused to a second metal layer made of an alloy of high corrosion resistance. The layer of corrosion resistant alloy may be provided at the surface in which the score is formed, i.e. the surface that is designated to be outside a container provided with the end wall (sometimes referred to as the “public” surface), or it may form the internal surface of the container (the surface on the “product” side) or even an internal layer of a three or more metal layer structure.

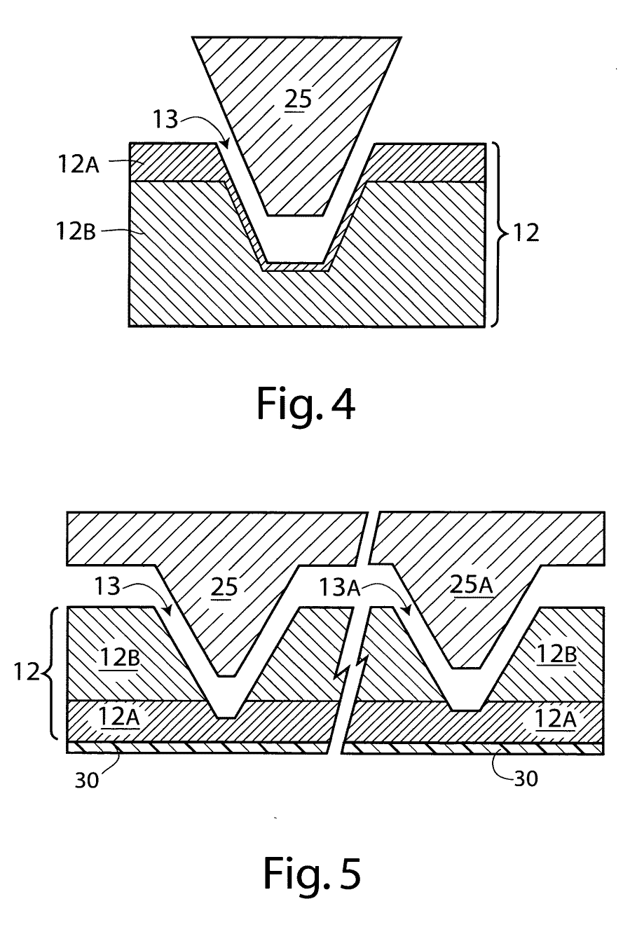

An arrangement of the first kind is shown in FIG. 4 which shows a section of the end wall corresponding to that of FIG. 2 or FIG. 3. In this drawing, a high strength layer 12B of the end wall 12 is covered at its outer surface with a corrosion resistant layer 12A of aluminum alloy. As the score 13 is being formed in the end wall (e.g. by a metal stamping operation utilizing a score tool 25), the corrosion resistant layer 12A is forced into the score 13 and, although reduced from its original thickness by attenuation, it still covers the interior surfaces of the score 13 without any break, even at the vulnerable bottom of the score. Therefore, corrosion is prevented or resisted within the score 13, even if stress fractures form in the underlying high strength layer 12B. Score tools usually cut through the metal surface rather than depressing the surface so, in this exemplary embodiment, it may be necessary to make the upper layer of corrosion resistant material quite thick, e.g. about two thirds of the total thickness) to ensure the desired coating effect.

An alternative exemplary embodiment is shown in FIG. 5. In this case, the end wall 12 is a two-metal-layer structure made of a layer 12A of good corrosion resistance provided beneath a layer 12B of high strength. This drawing also shows the formation of the adjacent scores 13, 13A of the Stolle design produced by two adjacent scoring tools 25 and 25A (which are not necessarily operated at the same time). The thickness of the layer 12B and the depth of penetration of the tools 25 and 25A are chosen such that both scores 13 and 13A have bottom parts that terminate within the layer 12A of corrosion resistant alloy, as shown. This ensures that any stress cracks that begin to form at the bottoms of the scores are cracks formed in metal of good corrosion resistance, thus reducing the risk of corrosion development and growth. The layer 12A need be no thicker than the minimum needed to ensure that stress cracks remain within the layer (although it may represent up to half the total thickness if desired). Layer 12B is of suitable thickness to produce an end wall having desired strength and buckle resistance. Providing the stronger alloy on the outside of the container end wall may have benefits in terms of buckle strength, thus allowing a thinner overall gauge to be used. Moreover, providing the corrosion resistant layer on the product side helps to control internal corrosion. If any of the high metal from high strength layer 12B is pushed by the scoring tools into the layer 12A, corrosion of such metal will not propagate into the layer 12A itself and and thus any tendency to generate stress cracking by such corrosion will be arrested. The scoring tools 25 and 25A may also be designed to cut through layer 12B (e.g. having a narrower tip), rather than to compress or punch into it like the tool of FIG. 4, so that minimal metal from layer 12B is carried into layer 12A. The increased hardness of layer 12B compared to 12A also makes it less likely that metal will be “smeared” into the underlying layer as the harder metal is less likely to flow under pressure. In addition to the metal layers, the internal surface may be coated with a protective layer 30 of lacquer or polymer material and, indeed, it is also normal to coat the public side of the end wall with a layer of lacquer or polymer, although this is not shown in the drawings.

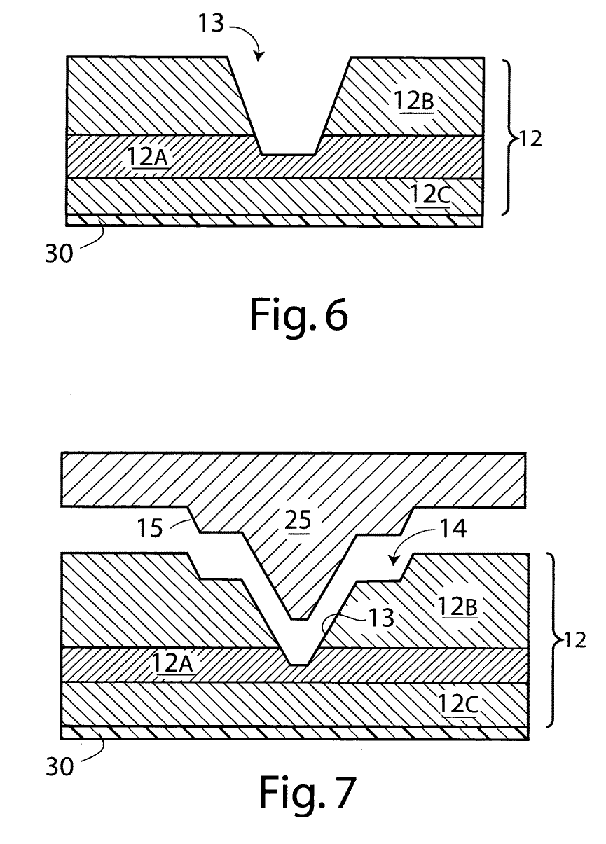

FIG. 6 shows an alternative exemplary embodiment in which an end wall 12 has a three-layer structure (three metal layers) made up of an outer layer 12B of high strength alloy, an internal layer 12A of alloy of good corrosion resistance and a further layer 12C of high strength alloy at the product side. The thickness and positioning of the internal layer 12A, as well as the thickness of the other layers and the force employed by the scoring tool, is made such that the score 13 penetrates this layer and has a bottom end terminating within the layer. Again, any stress cracks that form at the bottom end of the score 13 exist within an alloy of good resistance to corrosion, thus making corrosion less likely. The inner layer 12C assists the outer layer in producing an end wall of suitable high strength. Once again, the internal or product surface may be provided with a protective coating 30 of polymeric material or the like.

FIG. 7 shows yet a further alternative exemplary embodiment in which a three-layer structure similar to that of FIG. 6 is provided with a score 13 surrounded at its outer end with a shallow surface depression 14 formed by enlarged shoulders 15 of a scoring tool 25. This produces a score of the DRT coined design. Again, the score 13 terminates within a layer 12A of alloy of high corrosion resistance that is sandwiched between two layers 12B and 12C of metal of high strength. This reduces the risk of corrosion at the vulnerable bottom part of the score. Again, the inner wall 12 is provided with an internal coating 30 of plastics material or the like.

For all exemplary embodiments, the gauge of the container end wall must be suitable to provide the required strength and buckle resistance. Depending on the particularly design, this may be thinner or thicker than end walls of conventional design. Embodiments of the invention may be suitable to be used in thicknesses of 0.0080 inch (0.203 mm) or less (e.g. 0.0078 inch (0.198 mm)).

In all exemplary embodiments the high strength alloy is preferably chosen from AA5182, AA5042 and AA5082 (with alloy AA5182 being the most preferred). The alloy of good corrosion resistance is preferably selected from alloys AA3004, AA3104, AA5006 and AA5005 (with alloy AA5006 being the most preferred). For the high strength alloys, it may be desirable to increase the Mg content above that specified by a particular AA designation (e.g. above the 4-5 wt. % specified for AA5182) in order to increase the hardness even further to compensate for the lesser hardness of the corrosion resistant alloy. This may help to maintain the overall gauge of the end wall, or even to reduce it, without loss of buckle resistance, etc. The amount of the increase may be determined by trial and experimentation.

The composite metal sheet used to form container end wall 12 may be made by any suitable process, but it is particularly advantageous to prepare such sheet by rolling a composite (multi-layer) ingot produced by a direct chill (DC) casting operation. A process for producing a composite ingot suitable for this purpose is disclosed in US patent publication no. 2005/0011630, published on Jan. 20, 2005, in the name of Anderson et al. (the disclosure of which is incorporated herein by reference). This process produces an ingot and ultimately a metal sheet having a good bond between the constituent layers. Once the composite ingot has been cast it can be processed in the conventional manner and process steps may include homogenization, hot and cold rolling, together with other standard manufacturing steps and heat treatments as deemed necessary by the skilled person.

Alternatively, products according to the exemplary embodiments can be fabricated by more conventional methods known to those in the aluminum industry. For example, the products may be made by a traditional roll bonding approach where the layers are initially cast as separate ingots, homogenized and hot rolled to an intermediate thickness, then hot or cold rolled together to form the composite structure, followed by further rolling as necessary. As is known to the skilled person, various heat treatment steps may be incorporated within this process if necessary, such as but not limited to intermediate anneals or solution heat treatments.

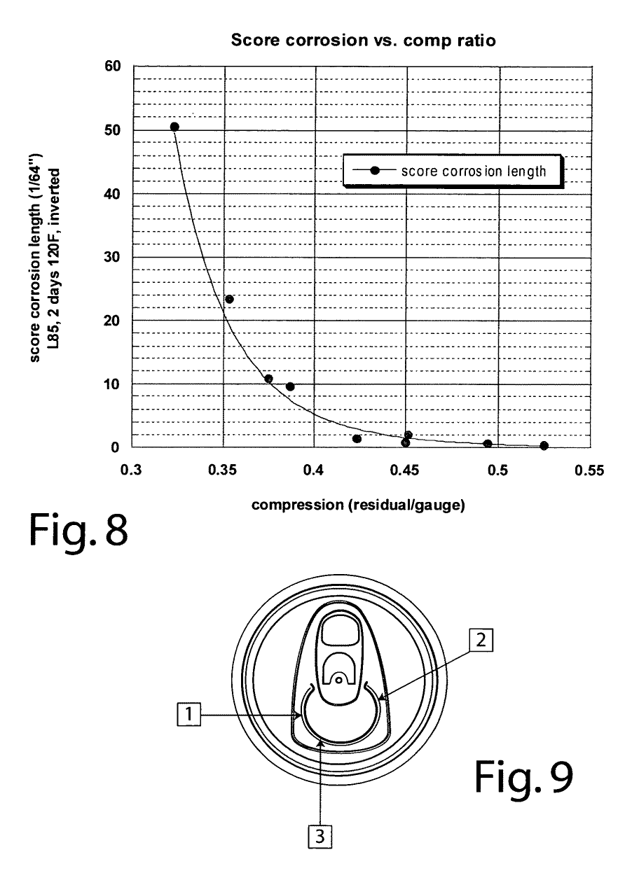

As indicated in the embodiments above, the surface of the container wall designated to form the interior of the container (product side) may be provided with a protective coating 30 of lacquer or polymer material. However, as shown in FIG. 3, this protective coating may fail to protect the interior of the container end wall from corrosion due to the compression that it undergoes during scoring. This effect is illustrated by the graph of FIG. 8 which shows the effect of compression (residual gauge as a proportion of original gauge) versus score corrosion length in a known corrosion test. The graph shows that corrosion increases rapidly when the residual gauge becomes lower than about 0.4 of the original gauge. It is therefore desirable, especially when the scoring is carried out with high compression, to utilize an end wall structure having a layer of alloy of good corrosion resistance at the intended internal surface of the container, e.g. as shown in FIG. 5. A three-layer structure based on that of FIG. 4 but providing an additional layer of alloy of good corrosion resistance at the inner surface of the container end wall (i.e. a sandwich of alloy of high strength between two outer layers of alloy of good corrosion resistance) would also be useful from this point of view.

For the exemplary embodiments, it may be desirable to modify or optimized the conventional design of the scoring tool. For example, a higher score tool face width has a lower probability of causing outside score corrosion. However, it puts more pressure on the product-side coating and may possibly generate a higher level of inside score corrosion. Benefits are obtained if the included angle of the primary and any secondary scoring tools are minimized in order to minimize metal flow or displacement. Typical angles in the 50 to 60 degree range are conventional. Optimization may therefore be desirable according to the container end wall design and thickness.

The following Example was carried out to provide further illustration of the exemplary embodiments.

### EXAMPLE

A sample beverage can end wall was made from a composite alloy sheet material having a core made of alloy AA5182 sandwiched between surface layers of alloy AA5005. The sheet material was rolled from a composite ingot produced according to the process of US patent publication no. 2005/0011630 by preheating, hot-rolling and cold-rolling to a thickness of 1.6 mm, and then further cold rolling was carried on a sheet mill to a final gauge of about 0.264 mm (0.0104 inch). The sheet was then lacquered, stamped and shaped, and scored with dual Stolle scores. The score presses were set to produce main (deeper) scores having a depth of 0.0.152 mm (0.0060 inch), leaving a residual metal thickness of 0.112 mm (0.0044 inch). The final design was a shown in FIG. 9 of the accompanying drawings. For comparison, samples of scores made in single metal layer end walls (of unialloy AA5182) were obtained.

The samples were embedded in mounting media, cross-sectioned in three locations (Locations 1, 2 and 3 as shown in FIG. 9) and examined with optical microscopes. The composite sample according to the exemplary embodiments, at Location 1, was then examined further with a scanning electron microscope (SEM).

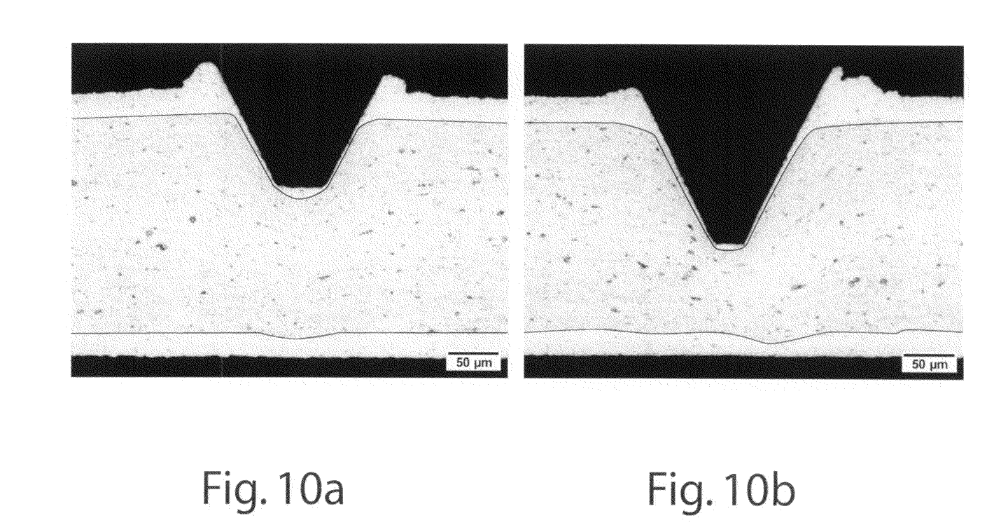

FIGS. 10a and 10b show the results of the microscopic examination of the composite product at Location 1 showing the inner score line (shallower score) in FIG. 10a and the outer score line (deeper score) in FIG. 10b. The layers of AA5005 alloy on the public and product sides appear as lighter bands compared to the core of alloy AA5182. The micrographs have been modified by providing a line showing the approximate position of the interfaces between the respective metal layers since these positions might otherwise be difficult to see in reproduced versions of the drawings.

The thickness of the layers of AA5005 are about 25 to 30 μm in thickness in untouched areas and it can be seen that thin layers remain along the walls of the scores and at the score bottoms. The thickness at the score bottoms (where corrosion is otherwise more likely) appears to be thicker than along the walls of the scores.

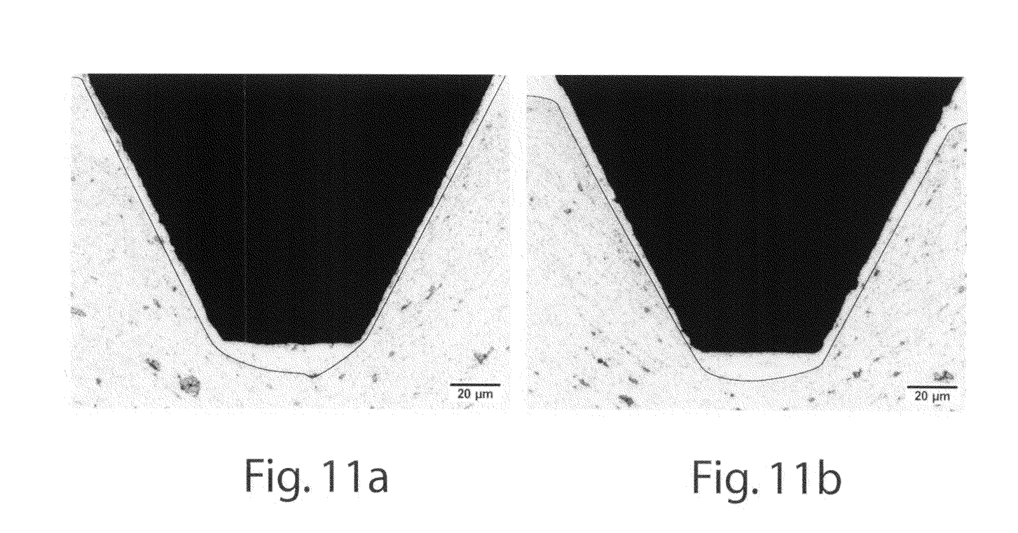

FIGS. 11a and 11b are close-ups of the shallower (inner) scores at Locations 2 and 3, respectively shown on an enlarged scale compared to FIGS. 10a and 10b. Again, the position of the metal-metal interface is emphasized by a drawn line. Layers of AA5005 alloy are visible at the sides and bottom of the scores. The situation at Location 1 (not shown) was similar.

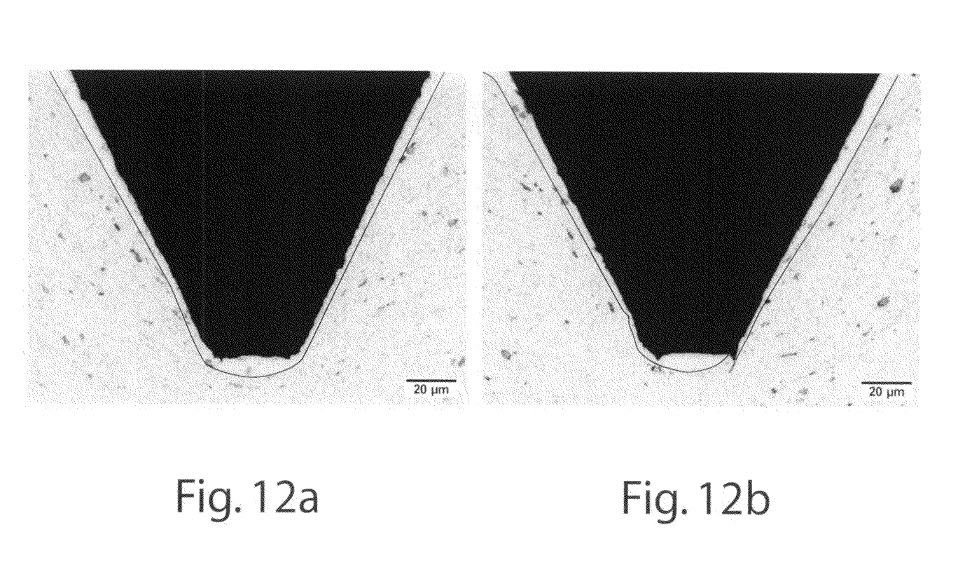

FIGS. 12a and 12b are views similar to FIGS. 11a and 11b, but showing the deeper (outer) scores at Locations 2 and 3, respectively, again with emphasis of the metal-metal interface. A thin layer of AA5005 can be seen along the sides of the scores with a somewhat thicker layer at the bottoms. The situation at Location 1 (not shown) was similar.

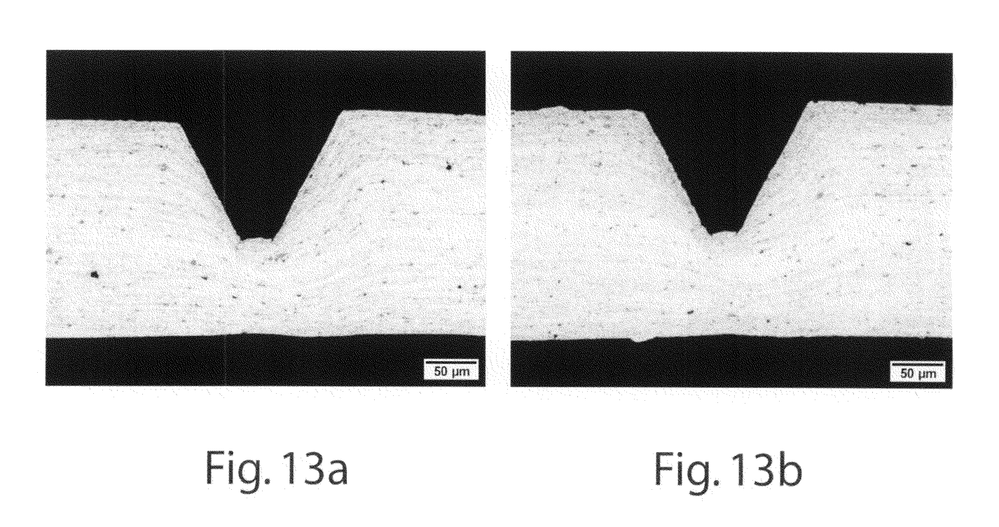

Conventional scored products are shown in the micrographs of FIGS. 13a and 13b for comparison. These show single layers of metal with small stress fractures at the bottom corners of the scores.

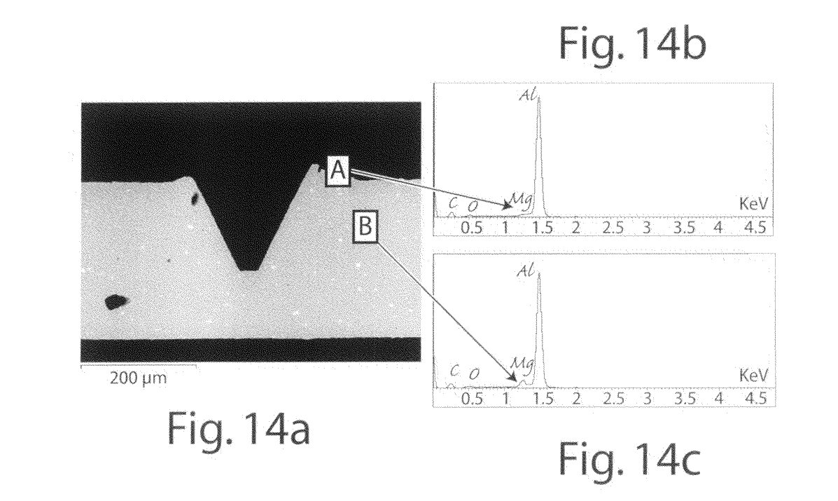

FIG. 14a is a micrograph of a score at Location 1 made from the same metal as shown in FIGS. 10a and 10b but without treatment to make the different layers more visible. Samples of the metal were taken from locations A and B shown in FIG. 14a and were subjected to analysis by a Scanning Electron Microscope. The resulting composition plots are shown in FIGS. 14b and 14c. The large peak on each plot is representative of the amount of Al (main alloy component). Mg appears at immediately adjacent, but slightly to the left, of the Al peak. In FIG. 14b, the Mg peak is very small (appears as just a shoulder leading to the Al peak). In FIG. 14c, the Mg peak is discernibly higher. This shows that the surface metal is low in Mg and the core metal is high in Mg, as would be expected from the positions of the surface layer of AA5005 and the core layer of AA5182.

These combined results show that there are layers of corrosion resistant alloy AA5005 on both sides of the core alloy of AA5182, the corrosion resistant alloy AA5005 forms distinct layers at the bottoms of both the deeper (outer) and shallower (inner) scores, with AA5005 extending decreasingly down the sides of the scores, and that the surface layers beyond the scores are about 25 to 30 microns thick.

Preliminary corrosion tests have shown zero failures of AA5006 aluminum alloy compared to 30% score line failures for conventional beverage can ends.

What we claim is:

1. An end wall for a metal container having a score therein, the end wall comprising a composite metal sheet made of two or more metal layers, one of the layers being made of an aluminum alloy of high strength, and another of the layers being made of an aluminum alloy having a good resistance to stress corrosion cracking, wherein at least a bottom of the score is formed by a surface of said alloy of good resistance to stress corrosion cracking.

2. The end wall of claim 1, wherein said one of said layers is made of an aluminum alloy having a magnesium content of 3 wt. % or more, and said another of said layers is made of an aluminum alloy having a magnesium content of less than 3 wt. %.

3. The end wall of claim 2, wherein said layer made of aluminum alloy of high strength comprises more than half of a total thickness of said end wall.

4. The end wall of claim 1, wherein said layer made of aluminum alloy of high strength comprises more than 80% of a total thickness of said end wall.

5. The end wall of claim 1, wherein said layer made of aluminum alloy of high strength contains 4 wt. % or more of magnesium.

6. The end wall of claim 1, wherein said layer made of aluminum alloy of high strength contains 4-5 wt. % of magnesium.

7. The end wall of claim 1, wherein said aluminum alloy of high strength is selected from the group consisting of alloy AA5182, alloy AA5042 and alloy AA5082.

8. The end wall of claim 1, wherein said aluminum alloy of good resistance to stress corrosion cracking is selected from the group consisting of alloy AA3004, alloy AA3104, alloy AA5006 and alloy AA5005.

9. The end wall of claim 1, wherein composite metal sheet comprises two layers, and said layer made of aluminum alloy having resistance to stress corrosion cracking is provided at a surface of said end wall in which said score is formed.

10. The end wall of claim 1, wherein composite metal sheet comprises two layers, and said layer made of aluminum alloy having strength is provided at a surface of said end wall in which said score is formed.

11. The end wall of claim 1, wherein said composite metal sheet has three layers, said layer made of aluminum alloy having good resistance to stress corrosion cracking being provided between two layers of said aluminum alloy having high strength.

12. The end wall of claim 1 having an additional score, said score and said additional score forming a Stolle dual score design.

13. The end wall of claim 1, wherein said score has a DRT coined design.

14. An end wall for a metal container having a score formed therein, said end wall comprising a composite metal sheet of at least two layers, wherein at least one of said layers is made of an alloy selected from the group consisting of alloy AA5182, alloy AA5042 and alloy AA5082, optionally with increased Mg, and wherein at least one other of said layers is made of an aluminum alloy selected from the group consisting of alloy AA3004, alloy AA3104, alloy AA5006 and alloy AA5005.

15. A metal container comprising a body having an open end and an end wall closing the open end of the body, wherein the end wall comprises a composite metal sheet made of two or more metal layers, one of the layers being made of an aluminum alloy of high strength, and another of the layers being made of an aluminum alloy having a good resistance to stress corrosion cracking, wherein at least a bottom of the score is formed by a surface of said alloy of good resistance to stress corrosion cracking.

16. The container of claim 15, wherein said one of said layers is made of an aluminum alloy having a magnesium content of 3 wt. % or more, and said another of said layers is made of an aluminum alloy having a magnesium content of less than 3 wt. %.
